(19) United States
(12) Patent Application Publication
(10) Pub. No.: US 2007/0113550 A1
(43) Pub. Date: May 24, 2007

(54) Turbocharger with a thin-walled turbine housing having a floating flange attachment to the centre housing

(76) Inventors: Lorrain Sausee, Vincey (FR); Raphael Hettinger, Thaou-Les-Vorges (FR); Manuel Dufin, Thaou-Les-Vorges (FR)

Correspondence Address: HONEYWELL TURBO TECHNOLOGIES, 23326 HAWTHORNE BOULEVARD, SUITE #200, TORRANCE, CA, 90505, US

(21) Appl. No.: 10/573,700

(22) PCT Filed: Oct. 24, 2003
(86) PCT No.: PCT/EP03/11851

§ 371 Date: Jan. 19, 2007

(51) Int. Cl. F02B 33/44

(52) U.S. Cl. 60/598; 60/605.1

(57) ABSTRACT

A turbocharger has a center housing (1) and a thin-walled exhaust housing (13). Both housings are connected to each other at cylindrical end portions (28, 27) thereof by use of a floating flange ring (16) having a clamping surface (26b) which upon applying an axial load exerts at least an axial force component for urging the cylindrical end portion (28) of the thin-walled housing (13) against the cylindrical end portion (27) of the center housing (1). The floating flange ring is connected to counter parts by screws, which counterparts are pressed against a flange portion of the center housing so as to clamp to walled housing by means of the floating flange ring.

The present invention relates to a turbocharger having a thin-walled turbine housing connected by a floating flange attachment comprising a floating flange ring.

Turbochargers are well known and widely used in connection with combustion engines. Exhaust gas from an engine is supplied to and drives a turbine wheel which drives a compressor wheel. The compressor wheel compresses air and discharges it into combustion chambers of respective cylinders. The thus compressed air contains an increased amount of oxygen per volume unit to enhance the combustion of fuel and thus to generate more power. Generally, the exhaust gas supplied to the turbine wheel is passed through an inlet and a volute to the turbine wheel and then exits through an outlet. In order to provide a light-weight turbine, the volute can simply be formed by a thin-walled turbine housing surrounding the turbine wheel and being connected to the center housing.

One example of an attachment of the thin-walled housing to the center housing is shown in the international application No. WO 02/06637 A1. Therein, the turbocharger comprises a center housing and an insert accommodating a turbine wheel. The center housing and the insert are connected to each other by means of bolts at their circumferentially outer portions. A thin-walled turbine housing surrounds the insert so as to constitute a volute through which the exhaust gas is supplied to drive the turbine wheel. A circumferential end portion of the thin-walled housing contacts the circumferential outer portion of the insert and an U- or V-band is laid around the outer portions of the center housing, the insert and the thin-walled housing and is tightened by bolts so as to clamp the end portion of the thin-walled housing to the insert. Thus, an attachment of the thin-walled housing to the remainder of the turbocharger is achieved.

The object of the invention is to provide an improved turbocharger having a thin-walled exhaust housing and a method for assembling thereof. A particular aim is to provide a reliable, leak proof and compact attachment of the thin-walled exhaust housing.

According to one aspect of the invention, the above object is achieved by a turbocharger having the features of claim 1 and claim 19, respectively. Preferable embodiments of the turbocharger are set forth in the subclaims.

In an exemplary embodiment of the invention, a turbocharger has a center housing and a thin-walled exhaust housing, wherein both housings are connected to each other at cylindrical end portions thereof by use of a floating flange ring having a clamping surface which upon applying an axial load exerts at least an axial force component for urging the end portion of the thin-walled housing against the end portion of the center housing. The use of an axial load enables good sealing properties of the housing portions. The floating flange ring can provide a sufficient stiffness, so that the axial load is securely provided at the whole circumference of the ring so as to secure an appropriate sealing reliability.

According to exemplary embodiments, the clamping surface may be slanted so as to exert a radial force component additionally to the axial force component. Furthermore, the clamping surface may be slanted such that said radial component is directed towards an axial center axis of said housing portions.

Additionally, the turbocharger may further comprise a counter part to the floating flange ring having a clamping surface on the side opposite to the clamping surface of the floating flange ring with respect to a flange-like projection forming the cylindrical end portion of the center housing. Furthermore, the attachment device may comprise at least a screw for applying said axial load between said counter part and said floating flange ring.

The floating flange ring may also be provided with at least three boss portions each receiving one of the screws, the boss portions projecting radially from the floating flange ring, and three washers, forming the counter parts, may be provided with the screws.

In an exemplary embodiment the bosses receive said screws in through holes and the screws may be tightened by means of nuts. The advantage of the through holes resides in that they are easy to machine. Alternatively, the bosses may receive said screws in blind holes having inner threads. This allows a space-saving arrangement and an easy assembly of the attachment device since no nuts are required to tighten the screws.

Furthermore, the bosses may be positioned at regular intervals on the circumference of the floating flange ring, which brings a well balanced distribution of the sealing forces between the housing portions induced by the axial loads of the screws in the bosses.

Additionally, adjacent to a tip end of the clamped end portion of the thin-walled housing portion a notch may be provided in the floating flange ring so as to be able to receive said tip end. Thus, a certain clearance for the thin-walled housing is provided, preventing stresses at the tip end portion of the thin-walled housing which could be provoked if the notch would not be provided. Furthermore, the notch also reduces stresses in the area of the notch itself.

Moreover, a single counter part in the form of a ring may be provided having bores at positions corresponding to the bosses for receiving each of the screws. This reduces the number of components and simplifies the assembling of the turbocharger.

The turbocharger may further comprise a sealing device disposed between the projection and the clamped end portion of the thin-walled housing. The sealing device improves sealing performance and further reduces stresses at the components to be connected. In an exemplary embodiment, the sealing device may have a four-sided cross-section one side of which may be slanted to be substantially parallel to the slanted clamping surface of the flange ring. Thus, the axial load provoked by the screws exerts an axial force component and a radial force component in the sealing device. Since the sealing device may also be in contact with the projection, an outer surface of an insert being mounted to the center housing and the clamped end portion of the thin-walled exhaust housing, the force components in the sealing device can then act on the two sides of the sealing device which are perpendicular to each other and which are opposite to the slanted side of the sealing device. This further improves the sealing performance since, in this case, the active sealing surface is enlarged, i.e. the two above mentioned perpendicular sides of the sealing device are activated.

Additionally, the sealing device may be made from a resilient material further improving sealing performance and reducing stresses.

Further, the cylindrical end portion of the exhaust housing may be slanted to be parallel to the slanted clamping surface of the floating flange ring. This will be advantageous in view of reducing stress when the sealing device having a slanted side is not provided.

The projection may have a substantially rectangular cross-section. Furthermore, the side of the projection facing the clamped end portion of the thin-walled exhaust portion may be parallel to the latter. This contributes to mountability and sealing performance of the turbocharger.

Furthermore, an exemplary method for assembling a turbocharger with a thin-walled housing, an inlet, a center housing and an insert is provided. The method comprises the following steps: orientating and holding a center housing assembly comprising the center housing and the insert by means of a jig; setting a thin-walled assembly comprising the thin-walled housing and the floating flange ring on the center housing assembly; bringing the inlet in contact with a jig portion which has a fixed orientation with respect to the jig so as to set the orientation of the inlet relative to the turbocharger.

In the following, further technical solutions of the object of the invention are described in detail with reference being made to the enclosed drawings, in which:

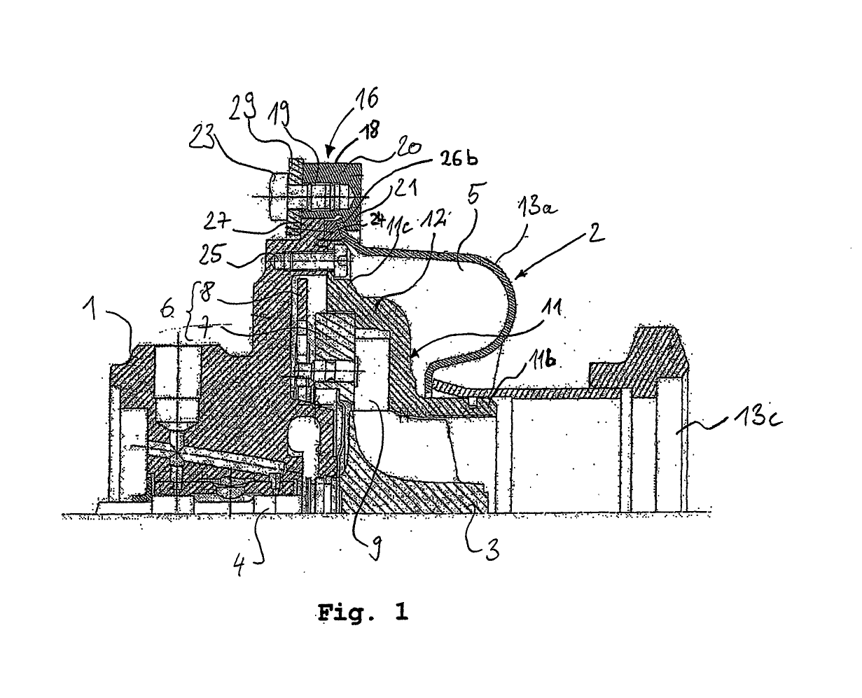

FIG. 1 is a sectional view of a part of a turbocharger where a turbine housing is connected to a center housing with a floating flange ring according to an embodiment of the invention;

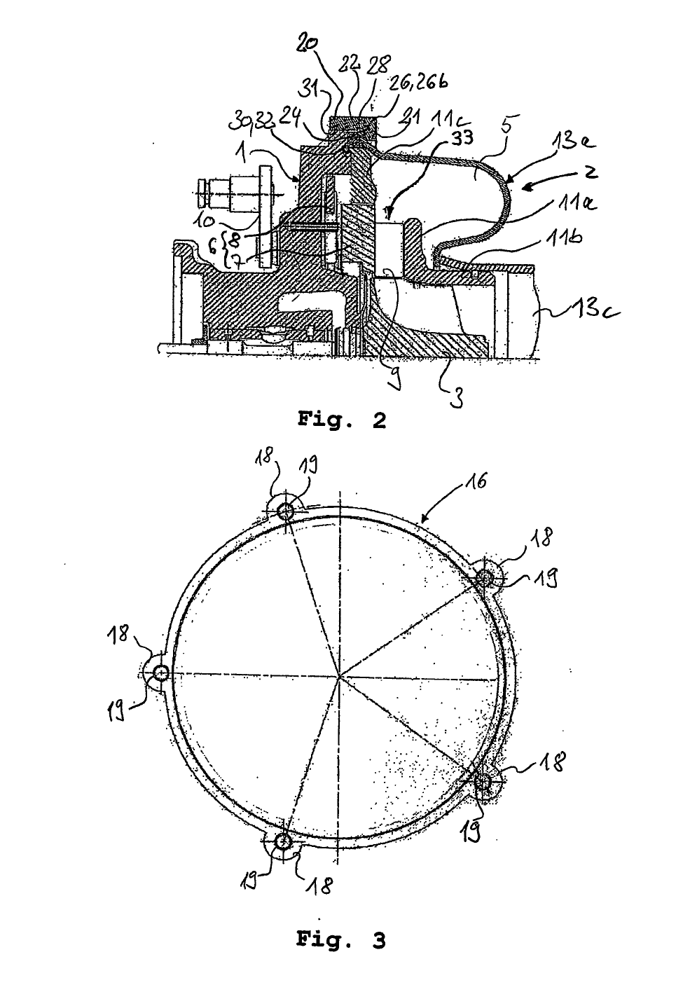

FIG. 2 is another sectional view of a part of the turbocharger wherein the turbine housing is connected to a center housing with the floating flange ring according to the embodiment of the invention;

FIG. 3 is a schematic front view of the floating flange according to the embodiment the invention (a view from the left side in FIG. 1 or 2);

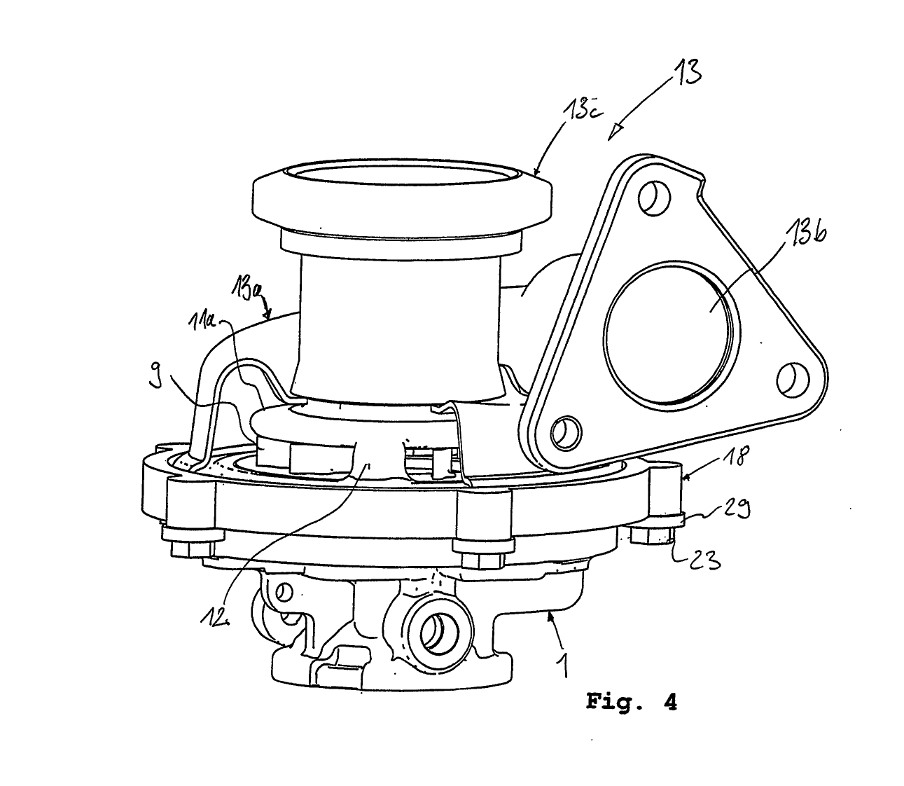

FIG. 4 is a perspective view of a part of the turbocharger, wherein the turbine housing is connected to the center housing with the floating flange ring according to the embodiment of the invention, wherein a thin-walled housing is partly cut away for illustrative reasons.

A turbocharger according to the embodiment shown in FIG. 1 comprises substantially a compressor housing (not shown) for accommodating a compressor wheel, a center housing 1 for accommodating a bearing assembly and a turbine housing assembly 2 for accommodating a turbine wheel 3. A shaft 4 extends through the center housing 1 so as to connect the turbine wheel 3 to the compressor wheel. Thus, the rotation of the turbine wheel 3 can be transmitted to the compressor wheel for compressing inlet air for an engine. The turbine wheel 3 is driven by exhaust gas coming from the engine and flowing through a volute 5 and an exhaust gas flow channel 33 (refer to FIG. 2) to the turbine wheel 3. A variable nozzle device 6 is interposed between the center housing 1 and a insert 11 which will be described latex. By means of the variable nozzle device 6, the rotational speed of the turbine wheel 3, and as well a rotational speed of the compressor wheel, can be set in accordance to the position of the variable nozzle device 6. The volute 5 is defined by a volute portion 13a of a thin-walled exhaust housing 13 (shown in FIG. 4) and the insert 11 which are parts of the turbine housing assembly 2. As shown in FIG. 4, the exhaust housing 13 further comprises an inlet portion 13b and an outlet portion 13c, these portions 13a, 13b, 13c being sheet metal parts (or casting parts) which are welded or formed together so as to constitute the thin walled exhaust housing 13.

As shown in another sectional view of a part of the turbocharger in FIG. 2, the nozzle device 6 comprises a nozzle ring 7 and an unison ring 8 which are rotatable relatively to each other by actuating a cam 10 so as to adjust an inclination of vanes 9 mounted to the nozzle ring 7.

As shown in FIGS. 1 and 2, the insert 11 comprises a tube portion 11b partly surrounding the turbine wheel 3 and a radially outward extending ring portion 11a connected to the tube portion 11b. The ring portion 11a constitutes, together with the nozzle ring 7, the exhaust gas flow channel 33 in which the vanes 9 are positioned to control the exhaust gas flow. Furthermore, the insert 11 comprises an attachment ring portion 11c which is connected to the ring portion 11a of the insert 11 via support posts 12. The support posts 12 are kept as small as possible so as not to interfere the exhaust gas flow into the exhaust gas flow channel 33 accommodating the vanes 9. Finally, the insert 11 is fixed to the center housing 1 via bolts 25 engaging the attachment ring portion 11c.

The insert 11 is surrounded by the thin-walled exhaust housing 13 having the inlet 13b and defining the volute 5 together with the insert 11. Accordingly, the exhaust gas coming from an engine (not shown) can enter the inlet 13b, flows through the volute 5 and through the plurality of exhaust gas flow channels 33 defined by the ring portion 11a of the insert 11, the nozzle ring 7 and the vanes 9, thus driving the turbine wheel 3 according to the adjustable inclination of the vanes 9, and then the exhaust gas exits through the outlet 13c connected to the tube portion 11b.

The center housing 1 comprises a circumferentially extending flange portion 27, forming a projection, having a substantially rectangular cross-sectional shape. This flange portion 27 has a larger outer diameter compared to that of the insert 11. Furthermore, the turbine side face of the flange portion 27 is, compared to the turbine side face of the center housing 1, offset in a direction towards the compressor side. Between these offset faces, a circumferentially extending groove 30 is disposed radially inward of the flange portion 27 so as to receive an annular projection 32 axially protruding from the attachment ring portion 11c of the insert 11. When assembling these parts together, a radially acting support and positioning means for the insert 11 is defined.

To fix the thin-walled exhaust housing 13 to the assembly of the center housing 1 a floating flange ring 16 according to the invention is used, which is shown in a front view in FIG. 3. The floating flange ring 16 is substantially ring shaped and has an inner diameter fitting to the outer diameter of the flange portion 27 of the center housing 1 (refer to FIGS. 1 and 2). Five bosses 18 are located at regular intervals at the outer circumferential area of the flange ring 16. Each boss 18 has a bore (blind hole) 19 extending in the axial direction of the floating flange ring 16 while having its aperture on the side facing the center housing 1. The bores 19 are provided with threads so as to receive screws 23. The floating flange ring 16 is floatingly mounted on the thin-walled exhaust housing 13—i.e. no form fit in the radial direction thereof is provided—so as to abut the internal surface of the outer diameter portion of the thin-walled exhaust housing 13 against the center housing 1 of the turbocharger.

As shown in FIGS. 1 and 2, the cross-sectional shape of the flange ring 16 at the portions between the bosses 18 is substantially L-shaped having an axially extending limb 20 and a radially extending limb 21. An inner face of the axially extending limb 20 fits with the outer diameter of the flange portion 27. An inner diameter of the radially extending limb 21 is smaller than the outer diameter of the flange portion 27 but larger than the outer diameter of the insert 11. The radially extending limb 21 is tapered from the tip thereof—a radially inner end of the radially extending limb 21—to the transition to the axially extending limb 20—a radially outer end of the radially extending limb 21. Accordingly, the thickness of the radially extending limb 21 increases in the radial outward direction and thus a inner slanted side 26b of the limb 21 is defined. A notch 22 is formed at the inner transition between the limbs 20 and 21.

The cross-sectional shape of the floating flange ring 16 at the portion of the bosses 18 (refer to FIG. 1) corresponds substantially to that of the portion between the bosses 18 (refer to FIG. 2) but is additionally adapted to receive the screw 23.

A four-sided sealing ring 24 made from a resilient material is provided such that one side thereof is in contact with the radially outer surface of the insert 11 and another face is in contact with the turbine side surface of the flange portion 27 of the center housing 1. A third side 26 of the sealing ring 24 is slanted with respect to the other sides, which are perpendicular/parallel to each other. The third side 26 is parallel to and faces the slanted side 26b of the radial limb 21 of the floating flange ring 16. A circumferential extending end portion 28 of the thin-walled exhaust housing 13 is sandwiched between the sealing ring 24 and the limb 21 of the floating flange ring 16. The end portion 28 is parallel to the slanted sides 26, 26b.

As shown in FIG. 1, a washer 29, forming a counter part according to the invention, having a through hole is aligned with the bore 19 of the boss 18 at the compressor side of the flange portion 27, i.e. the side opposite to the sealing 24 with respect to the flange portion 27 (left side in FIG. 1). The washers 29 extend radially inwardly over the boss 18 so as to engage the flange portion 27.

The length of the limb 20 is such that a small gap is defined between the floating flange ring 16 and the washer 29. When the screw 23 is tightened, the limb 21 presses the end portion 28 of the thin-walled exhaust housing 13 against the sealing ring 24 by pressing washers 29 against flange portion 27. Thus, the gap is minimized and the sealing ring 24 is compressed due to the axial load generated by the screw. Since the floating flange ring 16 has a certain stiffness, the axial pressure against the sealing ring 24 is sufficient also at the portions of the floating flange ring 16 between the bosses 18 and therefore the sealing performance is good all over the whole circumferentially extending attachment of the thin walled exhaust housing 13 to the center housing 1 and the insert 11.

Furthermore, due to the slanted side 26 of the sealing ring 24 and the slanted side 26b of the limb 21, the sealing ring 24 is compressed with an axial and a radial component against the turbine side face of the flange portion 27 and the radial outer face of the insert 11, respectively. Due to the two force components also two sides of the sealing ring 24 are activated and thus the active sealing surface is enlarged. This leads to an enhanced sealing performance of the attachment of the thin walled exhaust housing 13 to the center housing 1.

Additionally, since the turbine side face of the center housing 1 is offset in a direction towards the turbine compared to the turbine side face of the flange portion 27, a shear force in the annular projection 32 of the insert 11 can be reduced when tightening the bolts 23, leading to an improved reliability of the insert 11.

The attachment device as described above allows a larger axial clamp load in the joint due to the use of a convenient number of screws of convenient dimension.

The invention is not restricted to the above described embodiment and can be changed in various modifications.

For example, in the above described embodiment five bosses 18 are used for tightening the floating flange ring 16. However, an appropriate number of bosses 18 and bolts 23 can be provided for different dimensions or pressure conditions of the floating flange ring 16.

Alternatively, instead of using a plurality of single washers 29 it is possible to use one single washer ring having bores corresponding to the bores 19 of the flange ring 16. This reduces the number of components and simplifies the assembly.

Furthermore, the sealing ring 24 may be omitted and instead of the slanted side of the sealing ring 24 a respective side of the flange portion 27 may be suitably slanted.

1. A turbocharger having a center housing (1) and a thin-walled exhaust housing (13), both housings being connected to each other at cylindrical end portions (28, 27) thereof by use of a floating flange ring (16) having a clamping surface (26b) which exerts at least an axial force component for urging the end portion (28) of the thin-walled housing (13) against the end portion (27) of the center housing (1), characterized in that
the turbocharger further comprises at least a counter part (29) to the floating flange ring (16) having a clamping surface on the side of the end portion, which forms a flange portion (27), opposite to the clamping surface (26b) of the floating flange ring (16), wherein
said axial force component is exerted upon applying an axial load to said clamping surface (26b) by means of said counter part.

2. A turbocharger according to claim 1, wherein said clamping surface (26b) is slanted so as to exert a radial force component additionally to the axial force component.

3. A turbocharger according to claim 2, wherein said clamping surface (26b) is slanted such that said radial component is directed to the central axis of said housing portions.

4. A turbocharger according to any of claims 1 to 3, further comprising at least a screw (23) for applying said axial load between said counter part (29) and a boss (18) forming a part of said floating flange ring (16).

5. A turbocharger according to claim 4, wherein said floating flange ring (16) is provided with at least three bosses (18), each receiving one of the screws (23), the bosses (18) projecting radially from the floating flange ring (16), and at least three washers (19) form said counter part (19).

6. A turbocharger according to claim 5, wherein said bosses (18) receive said screws (23) in through holes and the screws (23) are tightened by means of nuts.

7. A turbocharger according to claim 6, wherein said bosses (18) receive said screws (23) in blind holes (19) having inner threads.

8. A turbocharger according to any of claims 5 to 7, wherein said bosses (18) are positioned at regular intervals.

9. A turbocharger according to any of the preceding claims, wherein adjacent to a tip end of the clamped end portion (28) of the thin-walled housing (13) a notch (22) is provided in the floating flange ring (16) so as to receive said tip end.

10. A turbocharger according to any of claims 1 to 9, wherein a single counter part (29) is provided having bores for each of the screws (23).

11. A turbocharger according to any of the preceding claims, further comprising a sealing device (24) disposed between the flange portion (27) and the end portion (28) of the thin-walled housing (13).

12. A turbocharger according to claim 11, wherein the sealing device (24) has a four-sided cross-section one side (26) of which is slanted to be parallel to the slanted clamping surface (26b) of the floating flange ring (16).

13. A turbocharger according to claim 11 or 12, wherein the sealing device (24) is in contact with flange portion the flange portion (27), an outer surface of an insert (11) being mounted to the center housing (1) and the clamped end portion (28) of the thin-walled exhaust housing (13).

14. A turbocharger according to any of claims 11 to 13, wherein the sealing device (24) is made from a resilient material.

15. A turbocharger according to any of the Preceding claims 1 to 14, wherein the clamped end portion (28) of the exhaust housing (13) is slanted to be parallel to the slanted clamping surface (26b) of the floating flange ring (16).

16. A turbocharger according to any of preceding claims 1 to 15, wherein said flange portion (27) has a substantially rectangular cross-section.

17. A turbocharger according to any of preceding claims 1 to 16, wherein the side of the flange portion (27) facing the clamped end portion (28) of the thin-walled exhaust portion (13) is parallel to the latter.

18. A method for assembling a turbocharger, comprising a thin-walled housing (13), an inlet (13b), a center housing (1) and an insert (11), having the features of any of the claims 1 to 17, the method being characterized in the following steps:
orientating and holding a center housing assembly comprising the center housing (1) and the insert (11) by means of a jig;
setting a thin-walled housing assembly comprising the thin-walled housing (13) and the floating flange ring (16) on the center housing assembly;
bringing the inlet (13b) in contact with a jig portion which has a fixed orientation with respect to said jig so as to set the orientation of the inlet (13b) relative to the turbocharger.
